(19) United States
(12) Patent Application Publication
(10) Pub. No.: US 2015/0334212 A1
(43) Pub. Date: Nov. 19, 2015

(54) Cell Phone Storage Apparatus

(71) Applicant: George Sandu, Des Plaines, IL (US)

(72) Inventor: George Sandu, Des Plaines, IL (US)

(21) Appl. No.: 14/279,086

(22) Filed: May 15, 2014

(51) Int. Cl. H04M 1/02

(52) U.S. Cl. CPC H04M 1/0279

(57) ABSTRACT

A cell phone storage apparatus for storing items with a cell phone is provided. The cell phone storage apparatus comprises a storage device secured to the cell phone and a plurality of compartments formed in the storage device. A lid is hingedly secured to the storage device with the lid closable over the compartments. Upon positioning the items in the compartments and closing the lid over the compartments, the items are storable with the cell phone.

The present application claims the benefit of priority of pending provisional patent application Ser. No. 61/823,942, filed on May 16, 2013, entitled “Cell Phone Wallet”.

### BACKGROUND OF THE INVENTION

1. Field of the Invention

This invention relates generally to a cell phone storage apparatus and, more particularly, the invention relates to a cell phone storage apparatus combining a cell phone holder with a wallet.

2. Description of the Prior Art

Modern cellular phones are widely used and enjoyed by members of the public, in a large part because sport a wide variety of engaging and highly entertaining applications that go well beyond regular telephonic and textual messaging services. Many phones now offer streaming video and television, allowing casual users to enjoy all their favorite programming on the go, as long as they keep their cellular contract paid and their telephone at their side. As a result, carrying about a cellular phone has become that habit of our age.

Wallets, equally, play a vital daily role in many different peoples' pockets. These handy contraptions, often constructed of fabric, leather or other pliable materials, provide a safe and secure place where all manner of ID cards, credit cards, cash money and receipts may be stored over the course of the days' time spent in public. Wallets are also similar to cellular phones in that they compete for scant real estate in the user's pockets as they seek a suitable location to while away the day. The end result of these two, conflicting drives, that to carry about a wallet and that to pocket ones cellular phone, is often the unsteady compromise of putting both devices in the pocket at once, and the general discomfort and organizational distress that such a compromise engenders.

### SUMMARY

The present invention is a cell phone storage apparatus for storing items with a cell phone. The cell phone storage apparatus comprises a storage device secured to the cell phone and a plurality of compartments formed in the storage device. A lid is hingedly secured to the storage device with the lid closable over the compartments. Upon positioning the items in the compartments and closing the lid over the compartments, the items are storable with the cell phone.

In addition, the present invention is a method for storing items with a cell phone. The method comprises securing a storage device to the cell phone, hingedly connecting a lid to the storage device, forming a plurality of compartments in the storage device, positioning the items in the compartments, closing the lid over the compartments, releasably securing the lid in a closed condition, and storing the items with the cell phone.

The present invention further includes a cell phone storage apparatus for storing items with a cell phone. The cell phone storage apparatus comprises a case surrounding at least a portion of the cell phone. A storage device is secured to the case and a plurality of compartments is formed in the storage device. A lid is hingedly secured to the storage device, the lid closable over the compartments. Upon positioning the items in the compartments and closing the lid over the compartments, the items are storable with the cell phone.

### BRIEF DESCRIPTION OF THE DRAWINGS

FIG. 1 is a perspective view illustrating a cell phone storage apparatus, constructed in accordance with the present invention, mounted to a cell phone with the cell phone storage apparatus being in a closed condition; FIG. 2 is a perspective view illustrating the cell phone storage apparatus of FIG. 1, constructed in accordance with the present invention, mounted to the cell phone with the cell phone storage apparatus being in an open condition; FIG. 3 is a perspective view illustrating another embodiment of the cell phone storage apparatus, constructed in accordance with the present invention, mounted to the cell phone with the cell phone storage apparatus being in a closed condition; and

FIG. 4 is a perspective view illustrating the cell phone storage apparatus of FIG. 3, constructed in accordance with the present invention, mounted to the cell phone with the cell phone storage apparatus being in an open condition.

### DETAILED DESCRIPTION OF THE PREFERRED EMBODIMENTS

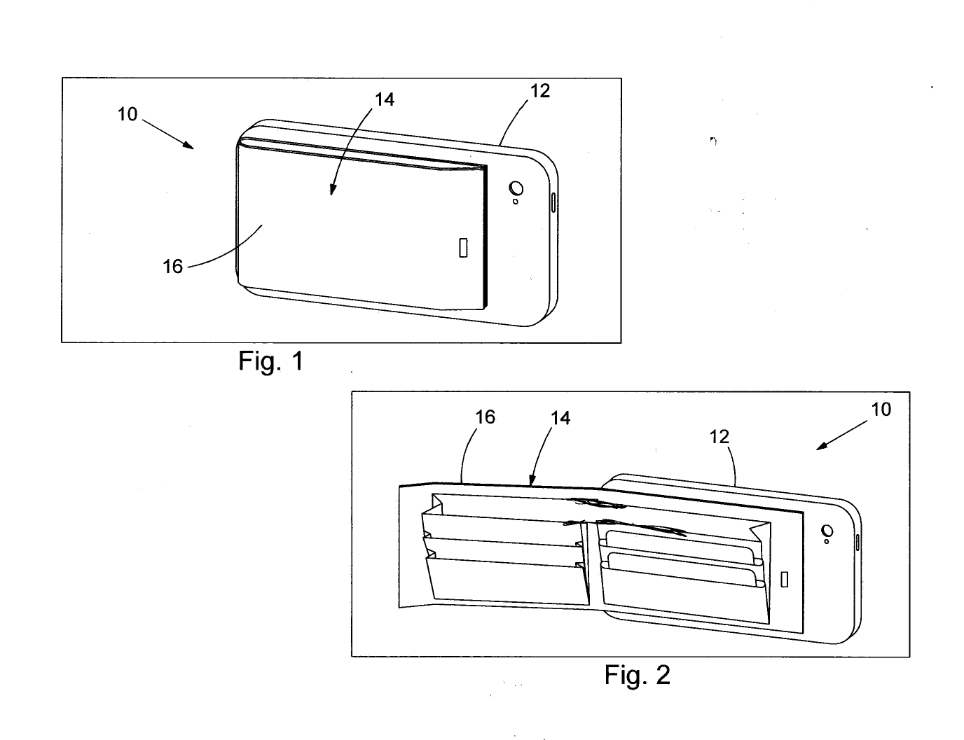

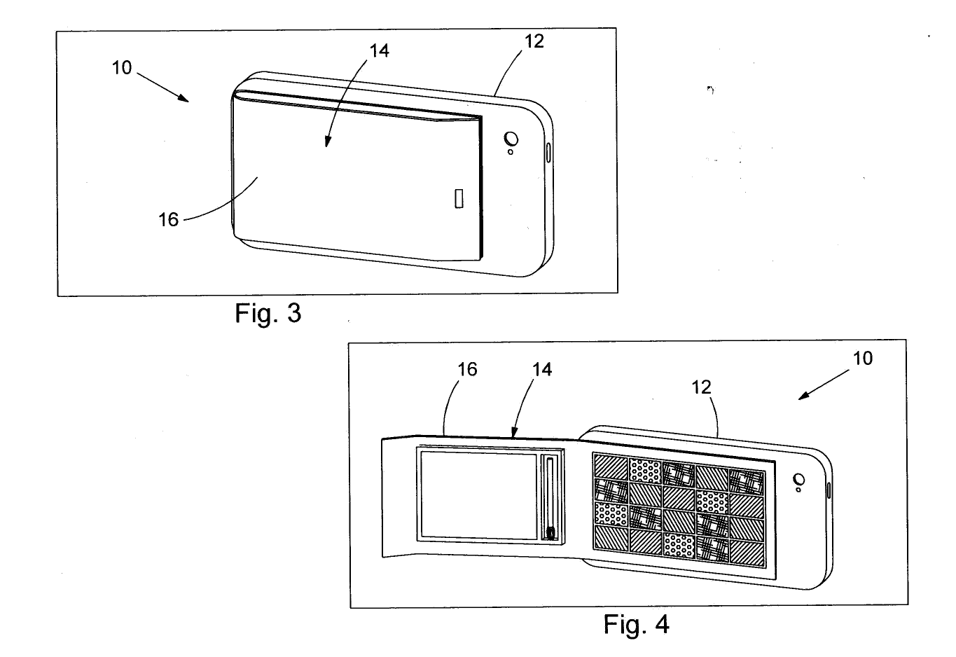

As illustrated in FIGS. 1-4, the present invention is a cell phone storage apparatus, indicated generally at 10, combining a cell phone case 12 with an attachable storage compartment 14. The cell phone storage apparatus 10 is preferably constructed from primarily a highly impact-resistant injection-molded hard plastic although constructing the cell phone storage apparatus 10 from other materials is within the scope of the present invention. In addition, the cell phone case 12 of the cell phone storage apparatus 10 can be constructed to accommodate all cell phones including the most populous models. The cell phone case 12 of the cell phone storage apparatus 10 are constructed with dimensions mirroring the rear surface of the device to which they are to be affixed.

It should be noted that the storage compartment 14 of the cell phone storage apparatus 10 of the present invention can be releasably secured to the cell phone case 12, permanently secured to the cell phone case 12, or manufactured integral with the cell phone case 12 depending on the desires of the manufacturer. Also, it is within the scope of the present invention for the storage compartment 14 to be secured directly to the cell phone rather than a cell phone case 12.

The storage compartment 14 of the cell phone storage apparatus 10 of the present invention features a hard, snap-open, snap-close cover 16 and offers the user a portion of usable space at least several millimeters deep and as wide and long as the cell phone itself In an embodiment of the cell phone storage apparatus 10, the storage compartment 14 can be a wallet with the interior space divided up into a number of different pockets or compartments, in order to better organize and manage a wide variety of different negotiable instruments. In another embodiment of the cell phone storage apparatus 10, the storage compartment 14 is constructed specifically for makeup has a mirrored surface on the inner face of the snap-close lid for personal makeup application examination, and divided bays and wells each containing different cosmetic products for direct application to the face concealed within the body of the device as well. Other arrangements of the storage compartment 14 can also be constructed, to handle everything from keys to credit cards, and the exterior faces of the storage apparatus 10 can be developed in all manner of different colors and patterns, including branded ones designed to convey a particular, targeted advertising message. The ready visibility, coupled with the relative inexpensiveness of the cell phone storage apparatus 10 and procedures employed in the construction of the cell phone storage apparatus 10 device, make it ideal for use as a promotional marketing give-away item.

The manner of use of the cell phone storage apparatus 10 of the present invention will now be described. It will be understood by those skilled in the art that the manner of use of the cell phone storage apparatus 10 described herein is merely one method of use and other methods of use of the cleaning tool device 10 are within the scope of the present invention.

Use of the cell phone storage apparatus 10 of the present invention is relatively easy and straight forward. First, the user selects a cell phone storage apparatus 10 model appropriate for their cell phone, with a decorative finish that is to their liking and which jives with their personal look. Once the appropriate cell phone storage apparatus 10 has been selected, it is purchased and removed from its protective wrapping. The storage compartment 14 can now be affixed to the rear panel of the cell phone case 12, using a pair of included non-marking double-sided adhesive patches. Once the storage compartment 14 has been directly secured to the cell phone case 12, it can be loaded up with the user's money, ID, credit cards and other wallet items, and then the entire package can be secreted about the user's person for later use. Whenever access to any of the contents is required, the user need simply extract the agglomerated device, snap open the cover of the storage compartment 14, and retrieve the required items. The cell phone storage apparatus 10 of the present invention offers users a simple and effective way to combine their two most important pocket items into a single item that takes up less space and is easier to keep track of By attaching to a wide variety of different types of phone, the storage apparatus 10 is ideal for serving the basic needs of a wide range of different customers.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only, to the claims except as precluded by the prior art. Moreover, the invention as disclosed herein may be suitably practiced in the absence of the specific elements which are disclosed herein.

What is claimed is:

1. A cell phone storage apparatus for storing items with a cell phone, the cell phone storage apparatus comprising:
a storage device secured to the cell phone;
a plurality of compartments formed in the storage device;
a lid hingedly secured to the storage device, the lid closable over the compartments; and
wherein upon positioning the items in the compartments and closing the lid over the compartments, the items are storable with the cell phone.

2. The cell phone storage apparatus of claim 1 wherein the storage device is constructed of a high impact-resistant injection-molded hard plastic.

3. The cell phone storage apparatus of claim 1 wherein the storage device is releasably secured to the cell phone.

4. The cell phone storage apparatus of claim 1 and further comprising:
a case for receiving the cell phone;
wherein the storage device is secured to the case.

5. The cell phone storage apparatus of claim 4 wherein the storage device is integral to the case.

6. The cell phone storage apparatus of claim 1 wherein the lid is releasably securable to the storage device when closed over the compartments.

7. The cell phone storage apparatus of claim 6 and further comprising:
a securing mechanism for releasably securing the lid in a closed position, the securing mechanism selected from the group consisting of a snap mechanism and a magnet mechanism.

8. The cell phone storage apparatus of claim 1 wherein the storage device is a wallet, the wallet having a plurality of pockets.

9. The cell phone storage apparatus of claim 1 wherein the storage device is a makeup case having at least one mirrored surface on the lid and a plurality of divided bays and wells.

10. The cell phone storage apparatus of claim 1 wherein the compartments are all the same size.

11. The cell phone storage apparatus of claim 1 wherein at least two of the compartments have a different size from each other.

12. The cell phone storage apparatus of claim 1 and further comprising:
an adhesive for securing the storage device to the cell phone.

13. A method for storing items with a cell phone, the method comprising:
securing a storage device to the cell phone;
hingedly connecting a lid to the storage device;
forming a plurality of compartments in the storage device;
positioning the items in the compartments;
closing the lid over the compartments;
releasably securing the lid in a closed condition; and
storing the items with the cell phone.

14. A cell phone storage apparatus for storing items with a cell phone, the cell phone storage apparatus comprising:
a case surrounding at least a portion of the cell phone;
a storage device secured to the case;
a plurality of compartments formed in the storage device;
a lid hingedly secured to the storage device, the lid closable over the compartments; and
wherein upon positioning the items in the compartments and closing the lid over the compartments, the items are storable with the cell phone.

15. The cell phone storage apparatus of claim 14 wherein the storage device is releasably secured to the case.

16. The cell phone storage apparatus of claim 14 wherein the lid is releasably securable to the storage device when closed over the compartments.

17. The cell phone storage apparatus of claim 16 and further comprising:
a securing mechanism for releasably securing the lid in a closed position, the securing mechanism selected from the group consisting of a snap mechanism and a magnet mechanism.

18. The cell phone storage apparatus of claim 14 wherein the storage device is a wallet, the wallet having a plurality of pockets.

19. The cell phone storage apparatus of claim 14 wherein the storage device is a makeup case having at least one mirrored surface on the lid and a plurality of divided bays and wells.

20. The cell phone storage apparatus of claim 14 and further comprising:
an adhesive for securing the storage device to the cell phone.
